(19) United States
(12) Patent Application Publication
(10) Pub. No.: US 2026/0299569 A1
(43) Pub. Date: Oct. 1, 2026

(54) UPDATING PROCESS GAINS FOR AN OPTIMIZATION PROCESS FOR AN INDUSTRIAL PLANT

(71) Applicant: Honeywell International Inc., Charlotte, NC (US)

(72) Inventors: Palavesh Kalyana Sundaram, Bangalore (IN); Abhishek Pednekar, West Hills, CA (US); John Goodman, Katy, TX (US); Vijayamahantesh Karpurmath, Bangalore (IN); Priyanka Saxena, Bengaluru (IN)

(73) Assignee: Honeywell International Inc., Charlotte, NC (US)

(21) Appl. No.: 19/091,005

(22) Filed: Mar. 26, 2025

(51) Int. Cl. G05B 19/418

(52) U.S. Cl. CPC G05B 19/41885

(57) ABSTRACT

A method for updating process gains for an optimization process for an industrial plant is provided. The method includes: receiving, from a site historian, data from the industrial plant at a historian of a digital twin of the industrial plant, the digital twin including process model functionalities that model the industrial plant including a plurality of independent variables and a plurality of controlled variables; preparing the data from the industrial plant for use by the process model functionalities; updating the process model functionalities with the prepared data; running the updated process model functionalities; extracting a matrix with a plurality of gains from the process model functionalities, wherein each gain of the plurality of gains associates one of the plurality of independent variables with a corresponding one of the plurality of controlled variables; passing data based on the matrix with the plurality of gains to an historian of an advanced process control system (APC); and controlling operation of the industrial plant through the APC system using the data based on the matrix with the plurality of gains received at the historian of the APC system.

### BACKGROUND

The Advanced Process Control (APC) system referred to in this invention relates to Model Predictive Control (MPC) of an industrial process. The APC system typically uses a dynamic model of the industrial process, derived from plant tests or manipulation of an appropriate model, to define both the process gains and dynamic responses between manipulated and disturbance variables and the controlled variables that define the objectives of the APC system.

Most industrial processes exhibit non-linear characteristics to a lesser or greater extent, that is the process gain varies as the plant operation changes. Deviations between the process gain in the plant and that in the APC system can lead to deterioration in the performance of the APC system leading to inefficiencies resulting in monetary loss due to operating below the optimum economic setpoint.

Delays in responding to process disturbances can lead to off-spec products, equipment damage, or safety incidents.

### SUMMARY

A method for updating process gains for an optimization process for an industrial plant is provided. The method includes: receiving, from a site historian, data from the industrial plant at a historian of a digital twin of the industrial plant, the digital twin including process model functionalities that model the industrial plant including a plurality of independent variables and a plurality of controlled variables; preparing the data from the industrial plant for use by the process model functionalities; updating the process model functionalities with the prepared data; running the updated process model functionalities; extracting a matrix with a plurality of gains from the process model functionalities, wherein each gain of the plurality of gains associates one of the plurality of independent variables with a corresponding one of the plurality of controlled variables; passing data based on the matrix with the plurality of gains to an historian of an advanced process control system (APC); and controlling operation of the industrial plant through the APC system using the data based on the matrix with the plurality of gains received at the historian of the APC system.

### BRIEF DESCRIPTION OF THE DRAWINGS

Embodiments of the present invention can be more easily understood and further advantages and uses thereof more readily apparent, when considered in view of the description of the preferred embodiments and the following figures in which:

FIG. 1 is a block diagram of one embodiment for a system that updates process gains generated by a process digital twin for use by an optimization process for controlling an industrial plant.

FIG. 2 is a flow chart of one embodiment of a process for updating process gains for an optimization process for controlling an industrial plant.

FIG. 3 is a block diagram of one embodiment of a flowsheet model of industrial plant that produces updates to process gains for use by the optimization process for the industrial plant.

FIG. 4 is a screenshot of a graphical user interface on an operator console of an one embodiment of an advanced process control system associated with the flowsheet model of FIG. 3 that illustrates various values for parameters associated with controlled variables (CV), manipulated variables (MV), and disturbance variable (DV).

FIG. 5 is screenshot of a graphical user interface that illustrates one embodiment of a process for updating process gains for an optimization process for an industrial plant associated with the flowsheet model of FIG. 3.

FIG. 6. is one embodiment of a system for plant-wide optimization using updated process gains based on current operating conditions of an industrial plant.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

### OVERVIEW OF DISCLOSURE

Various embodiments of the present disclosure address technical challenges related to providing accurate steady state gains to be used by an advanced process control system using modeling and/or simulating processes associated with, for example, an industrial plant (e.g., gas processing plans, oil refineries, and/or the like). Such modeling and simulating may be used to monitor, control, and/or optimize equipment and processes of an industrial plant.

However, over time, the operation of the various processes and equipment changes due to changing process conditions, environmental factors such as heat and humidity, wear and tear, and other issues that change the operation of the industrial plant. As the operation of the industrial plant changes, the embedded APC models no longer accurately reflect the current state of the industrial plant. Thus the adjustments to the manipulated variables of the APC system may be sub-optimal.

Various embodiments of the present disclosure improve the performance of the APC system by updating the models embedded within the advanced process control. For example, in some embodiments, the state of the industrial plant is monitored by a plurality of sensors that record data for a plurality of variables that are indicative of the state of the plant.

This data from the plurality of sensors is recorded and passed to a digital twin of the industrial plant. The digital twin uses the data to update the model, including but not limited to, updating a steady state gain matrix for the process model. The digital twin then provides the updated steady state gain matrix to the advanced process control system to replace prior instances of the gain matrix. In this way, the advanced process control system uses up-to-date information on the state of the industrial plant and is enabled to provide accurate control signals to optimize the output of the industrial plant.

### DEFINITION OF TERMS

Digital Twin. The term ‘Digital twin” refers to a digital, model-based representation (virtual replica) of physical components (e.g., equipment, system, processes, etc.), an object, a person or a process. Digital Twins use real-time data to simulate and predict how the physical counterpart will perform. As such, the Digital Twins may be linked to real-world data sources, such as sensors on or associated with a physical component, equipment, system or process. In one or more embodiments, a digital twin model is configured to run with plant data in that incoming data (e.g., operational data) from the plant is fed into the digital twin model to update the digital twin model. As such, a digital twin model may describe a representation of equipment, systems, and/or processes of an industrial plant that reflects the current operating conditions of the industrial plant. A digital twin model may be used to monitor, refine, control, predict, and/or optimize operations of the industrial plant. In some embodiments, the digital twin model may comprise one or more process simulation models and/or one or more data-driven models. The data-driven models may comprise intelligent models.

Historian. In a process control system, a “historian” is a specialized software application that continuously collects, stores, and organizes time-series data from various sensors and controllers within an industrial plant or process, allowing operators and engineers to analyze historical trends and identify patterns for better decision-making and process optimization; essentially acting as a centralized database for operational data. In some embodiments, the data historian, or simply, the historian, is a type of database that is designed to collect and store time-series data from various sources around the industrial plant or process plant.

Industrial plant. The term “industrial plant,” “plant,” and/or similar terms used herein interchangeably may refer to one or more buildings, complex, or arrangement of components that perform a chemical, physical, electrical, mechanical process, and/or the like for converting input materials into one or more output products. Non-limiting examples of an industrial plant include a chemical industrial plant, automotive manufacturing plant, distillery, oil refinery, fabric manufacturing plant, and/or the like.

Independent variables. The term independent variable means, or includes, disturbance variables and manipulated variables.

Disturbance variables. In process control, a “disturbance variable” refers to a variable that affects the process output but is not directly controlled by the control system, meaning it is an external factor that can cause fluctuations in the desired process variable, even when the control loop is actively trying to maintain a setpoint; essentially, it's a factor that disrupts the normal operation of the process that the controller cannot directly manipulate.

Advanced process control system. An “advanced process control” (APC) system, in control theory, refers to a broad range of techniques and technologies implemented within industrial process control systems. Advanced process controls are usually deployed optionally and in addition to basic process controls. Basic process controls are designed and built with the process itself, to facilitate basic operation, control and automation requirements. Advanced process controls are typically added subsequently to address particular performance or economic improvement opportunities in the process, such as process optimization.

Process control (basic and advanced) normally implies the process industries, which includes chemicals, petrochemicals, oil and mineral refining, food processing, pharmaceuticals, power generation, etc. These industries include continuous and batch processes.

Flowsheet model. The term “flowsheet model” may refer to a model-based representation of one or more processes of an industrial plant. A flowsheet model may be configured to facilitate designing, developing, analyzing, monitoring, controlling, optimizing, and/or the like one or more processes of the industrial plant. Such processes for example, may include chemical processes, biological processes, and/or the like. In one or more embodiments, a flowsheet describes the process flow through an industrial plant. In a non-limiting example, a flowsheet model includes a plurality of first principles models of physical components that are interconnected to model an industrial plant.

Controlled Variables. In process control, a “controlled variable” refers to the specific output quantity or condition that a control system actively monitors and attempts to maintain at a desired setpoint or within a desired range, essentially the variable that is being regulated within a process by adjusting other related variables like flow rate or temperature.

Manipulated Variables. The term “manipulated variable” may refer to a variable that can be controlled in the process and directly affects the output of the process. The manipulated variable is adjusted in order to alter the value of at least one controlled variable.

Gain. The term “gain” or “process gain” may refer to a ratio of a change in a process output (controlled variable) to a process input (e.g., an independent variable such as a manipulated variable or disturbance variable). Each gain is a real number that is calculated as a ratio of a change in the controlled variable divided by the change in the independent variable that caused the change in the controlled variable.

Gain Matrix. The term “gain matrix” may refer to a matrix of real numbers, with each number representing a gain between a corresponding pair of variables, e.g., between a manipulated variable (MV) or a disturbance variable (DV) and a controlled variable (CV), for the industrial plant. For example, each column may represent a manipulated variable or a disturbance variable and each row may represent a controlled variable. The real number at the intersection of a particular row and column represents the gain of the controlled variable of the associated row to the manipulated variable or disturbance variable of the associated column.

Physical Component. The term “physical component,” “object,” “process module,” or “process unit” with respect to an industrial plant may refer to asset(s) within or associated with the industrial plant. Such assets, for example, may include real-world equipment, system, or other physical structure within and/or associated with the industrial plant, and that is utilized by the industrial plant. For example, a physical component with respect to an industrial plant may comprise equipment, system, or other structure that is utilized in a process performed by the industrial plant. In an example context of an oil refinery plant, non-limiting examples of a physical component may include a furnace, a pump, a heat exchanger, and/or the like.

First Principles Model. The term “first principles model” may refer to a model-based representation of one or more processes of an industrial plant based on fundamental laws of physics, thermodynamics, kinetics, chemistry, etc. For example, a feed stream associated with a gas refrigeration plant may be defined in a first principles model in terms of its physical and/or chemical properties. As another example, a feed stream associated with a crude oil processing plant may be defined in a first principles model in terms of its physical and/or chemical properties. In some embodiments a first principles model is configured to generate model-predicted data that includes predicted values for one or more process variables associated with a process (e.g., of the industrial plant) represented in the first principles model. One or more inputs to a first principles model may be fixed input(s), while one or more inputs to the process simulation model may be variable input(s). Additionally or alternatively, one or more inputs to a first principles model may be a computed value, for example, by the first principles model and/or by a predictive model such as a machine learning model or artificial intelligent model. Additionally or alternatively, one or more inputs to the first principles model may comprise data received from the industrial plant whose process(es) is modeled by the first principles model. As a non-limiting example, such data received from an industrial plant may comprise process variable measurements (e.g., sensor-based measurements). In some examples, a first principles model may be configured for online simulation and/or offline simulation. In one or more embodiments, execution of a first principles model includes performing one or more operations. As a non-limiting example, the one or more operations may include an optimization operation with respect to one or more objective functions (e.g., minimum energy, maximum production, maximum profit, minimum cost, and/or the like) in order to determine optimal operating points/conditions for one or more output process variables. An optimal operating point/condition for an output process variable, for example, may describe a stable operating point/condition for the output process variable. In some embodiments, a first principles model may include a steady-state model or a dynamic model. For example, in some embodiments a first principles model may simulate a steady state process and/or a dynamic process. In some embodiments, a first principles model may be associated with or otherwise embodied by a digital twin model.

Sequential Mode Model (perturbation). A sequential mode model is one in which the unit operations that make up model representation of the process unit are self contained and solved one after the other. Recycle operations provide estimates for information that returns to upstream unit operations from downstream operations and the model iterates until the estimates match the new calculation. The gain matrix for a sequential mode model is derived by sequentially adjusting individual independent variables (manipulated variables or disturbance variables) and recording changes in the controlled variables. These changes are captured in terms of “gains.” In various embodiments, adjusting an independent variable may result in changes to one or more controlled variables. The gains created by the sequential mode model are captured in a gain matrix.

Gain model/Flowsheet model/Process Model. The term “flowsheet model” may refer to a model-based representation of one or more processes of an industrial plant. A flowsheet model may be configured to facilitate designing, developing, analyzing, monitoring, controlling, optimizing, and/or the like one or more processes of the industrial plant. Such processes for example, may include chemical processes, biological processes, and/or the like. In one or more embodiments, a flowsheet describes the process flow through an industrial plant. In a non-limiting example, a flowsheet model include a plurality of first principles models of physical components that are interconnected to model an industrial plant.

Open Equation Model. An “open equation model” refers to a mathematical model where the equations describing the unit operations are explicitly written in a form that allows for the simultaneous solution of the whole flowsheet including recycles and optimization calculations using advanced mathematical solvers. The gain matrix for open equation models can be generated at the same time that the process model solves without the need to sequentially adjust individual independent variables.

### Using a Digital Twin to Update Process Gains for Controlling Industrial Plant

Embodiments of the present invention periodically update the steady state gain information used by the advanced process control system to overcome the above-identified problems. Basically, a process digital twin receives data from sensors in the industrial plant and updates its model of the industrial plant to reflect the current state of the industrial plant. As a result, the process digital twin can produce updated steady state gains that reflect the current operating state of the industrial plant. These updates to the steady state gains are provided to the advanced process control system thereby improving the stability and responsiveness of the advanced process control system and leading to overall system optimization.

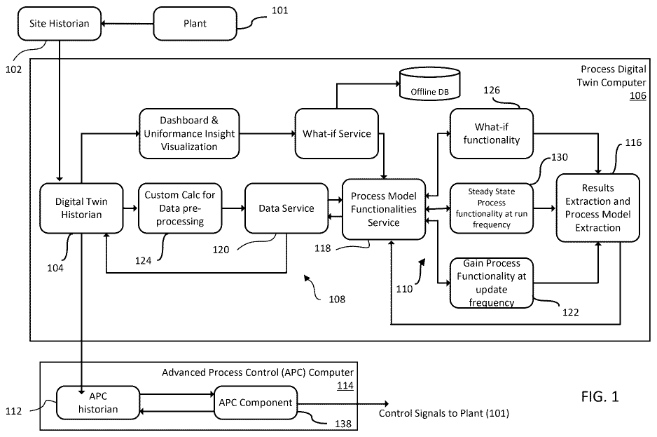

FIG. 1 is a block diagram of one embodiment for a system 100 that updates steady state process gains generated by process digital twin computer 106 for use by an optimization process for controlling an industrial plant 101. As mentioned, the process digital twin computer 106 periodically updates the steady state gains employed by an advanced process control system deployed on an advanced process control computer 114. It is understood that the advanced process control computer system and process digital twin computer systems may be comprised of one or more servers, standalone computers, or virtual computers hosted on physical assets at the customer location or in the cloud, or any other appropriate system that includes a processor and memory for executing program code to perform the functions of the advanced process control system.

To update the steady state gains of industrial plant 101, process digital twin computer 106 receives data regarding the current operating state of the various equipment, process units, and processes in the industrial plant 101. This data is gathered by a plurality of sensors located throughout industrial plant 101. The sensors report data regarding the various equipment, process units, and processes over time, e.g., at selected intervals or based on the occurrence of certain events or triggers. The data from the sensors is reported to, and gathered by, site historian 102. Site historian 102 stores data from the sensors and the like associated with the various equipment, process units, and processes of industrial plant 101.

Site historian 102 provides the data gathered from the sensors to process digital twin computer 106. Process digital twin computer 106 stores the data, when received, in digital twin historian 104 associated with the process digital twin computer 106. The process digital twin computer 106 includes a steady state process model of the industrial plant 101 including a plurality of independent variables (manipulated variables and disturbance variables), a plurality of controlled variables, and a matrix with a plurality of gains. Each gain of the plurality of gains associates one of the plurality of independent variables with a corresponding one of the plurality of controlled variables.

The data in digital twin historian 104 is processed (108) to be prepared for use to update the steady state model. In this example, process 108 includes custom calculations for data pre-processing 124. Data pre-processing 124 performs calculations that are specific to the data received from industrial plant 101. Data service 120 performs more standard data manipulation to prepare the data for use by the process model. Specifically, data service 120 may clean, transform, filter, and format the data so that it is ready for use by the process model. For example, data service 120 may account for missing values, reduce noise in the data, detect and treat outliers and ensure that all data is of the correct format. Once the data is processed, data service 120 pushes the data to the process model functionalities service 118.

As shown, process digital twin computer 106 implements up to three process model functionalities (indicated at 110): what-if functionality 126, steady-state process functionality 130 and gain process functionality 122. These functions may be provided by individual models or multiple functionalities provided by a combined model. It is noted that what-if functionality 126 is not normally aligned with live process data and is used for offline and alternative studies and consequently is not normally used in the APC gain update process. The steady-state process functionality 130 is run periodically based on the new data received from the site historian 102 via digital twin historian 104, data pre-processing 124, data service 120 and process model functionality service 118. The new data received from process model functionalities service 118 ensures that the process model functionalities 110 reflect the current state of industrial plant 101. Thus, the process model functionalities 110 are enabled to produce output data on the current capabilities of industrial plant 101 such that data can be generated by the embedded APC models and used by advanced process control computer 114 to accurately monitor, control and/or optimize the operation of industrial plant 101.

Steady-state process functionality 130 is run periodically, e.g., every hour, every two hours, every four hours, etc. The output of steady-state process functionality 130 is a snap shot of the steady state operation of industrial plant 101. Results extraction and process model extraction 116 captures the output of process model functionalities 110. It is noted that a snapshot does not need to be taken every run of process model functionalities 110. For example, if steady-state process functionality 130 has a run frequency of hourly, results extraction and process model extraction 116 may only record the snap shot every two hours or every four hours. Further, results extraction and process model extraction 116 also takes a snap shot of the process model functionalities 110 for archival purposes.

As part of the output of the process model functionalities 110 (captured at results extraction and process model extraction 116), the matrix with the plurality of gains is produced. This data is passed back to the digital twin historian 104 via process model functionalities service 118 and data service 120.

The gain matrix may be derived in at least two ways depending on the type of steady state model: sequential or open equation. First, in one embodiment, the steady state process functionality 110 creates the matrix with the plurality of gains using the sequential mode. This mode replicates the steps that were originally done in the design of the advanced process control system. In this mode, also referred to as the “perturbation method,” steady state process functionality 130 sequentially adjusts each independent variable (manipulated variable and disturbance variable) and records a value for the change in each associated controlled variable. With this approach, a gain is determined for each independent variable (e.g., manipulated variable and disturbance variable) and each of its corresponding controlled variables by dividing the change in the controlled variable by the change in the corresponding independent variable (the amount of the perturbation). The sequential mode also uses gain process functionality 122 in generating the gain matrix.

In a second embodiment, an open equation model is used in steady state process functionality 130. When the open equation model is run with the new data from the client historian, the matrix with the plurality of gains is created as part of the output of the open equation model as described above. As a result, the open equation model provides the gain information between all of the fixed variables and all of the calculated variables; the manipulated variables and disturbance variables are subsets of the fixed variables and the controlled variables are subsets of the calculated variables. As a result, all of the derivative information (change in controlled variable to change in independent variable) is available. With the open equation model, the gain matrix is produced by steady state process functionality 130 without any processing by gain process functionality 122. The gain matrix is extracted by results extraction and process model extraction 116.

The digital twin historian 104 passes the matrix with the plurality of gains to advanced process control (APC) historian 112 of an advanced process control (APC) computer 114 for use in controlling operation of the industrial plant 101. In one embodiment, passing the matrix with the plurality of gains includes determining a difference between the plurality of gains in the gain matrix and a corresponding plurality of gains in a prior gain matrix generated by the process models. This difference is deployed to the APC historian 112 as a multiplication factor for use by the advanced process control computer 114. For example, in one embodiment difference is determined by dividing the gain matrix by the prior matrix. In other embodiments, digital twin historian 104 provides the new gain matrix directly to advanced process control historian 112.

Advanced process control computer 114 uses the updated gain matrix to determine new control signals for industrial plant 101. Specifically, advanced process control computer 114 includes advanced process control component 138 that is configured to generate control signals to optimize performance of industrial plant 101. When the new gain matrix is received at historian 112, advanced process control component 138 is configured to re-calculate values for the manipulated variables that are used to control industrial plant 101. These new values are communicated to industrial plant 101 by advanced process control component 138 so that operation of industrial plant 101 is optimized based on the current operational state of industrial plant 101 as reflected by the modification of the process models in process digital twin computer 106 based on the updated data provided by site historian 102.

### Process for Updating Gains for Controlling an Industrial Plant

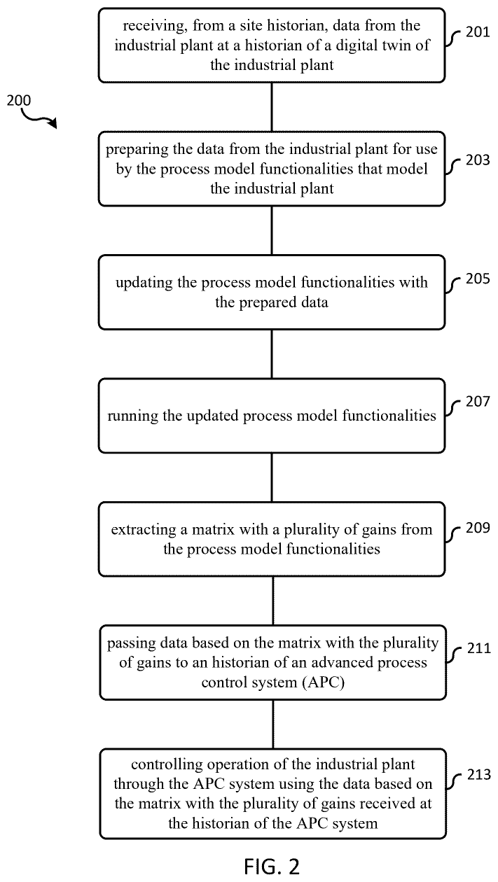

FIG. 2 is a flow chart of one embodiment of a process 200 for updating process gains for an optimization process for controlling an industrial plant. Process 200 is described below with reference to system 100 of FIG. 1. It is understood, however, that process 200 is not limited to use with system 100 of FIG. 1. References to FIG. 1 in the description of process 200 are provided to give an example context for process 200.

Process 200 receives data on the current state of industrial plant 101 at block 201. In the embodiment of FIG. 1, process 200 receives the data from site historian 102, which, as explained above, receives the data from a plurality of sensor spread throughout industrial plant 101. Process 200 receives the data at, for example, digital twin historian 104 of process digital twin computer 106.

At block 203, process 200 prepares the data for industrial plant 101 for use by the process model functionalities 110 that model industrial plant 101. In one embodiment, preparing the data includes custom calculations based on the specific industrial plant 101 (data pre-processing 124 described above). Further, process 200 prepares the data by performing standard data manipulation to prepare the data for use by the process model such as: clean, transform, filter, and format the data so that it is ready for use by the process model (such as by Data service 120). Further, such data preparation may account for missing values, reduce noise in the data, detect and treat outliers and ensure that all data is of the correct format.

At block 205, process 200 updates the process model functionalities 110 with the prepared data from block 203. This update ensures that the process model functionalities 110 reflect the current state of industrial plant 101. Thus, the process model functionalities 110 can provide updated data to advanced process control system, e,g, advanced process control computer 114 to enable advanced process control computer 114 to accurately control the operation of industrial plant 101.

At block 207, process 200 runs the updated process model functionalities 110 to produce modified data for advanced process control computer 114. At block 209, process 200 extracts a gain matrix with a plurality of process gains from the process model functionalities 110.

In one embodiment, the process model functionalities 110 use an open equation model (such as described above with respect to steady state process functionality 130). When this model is run, the gain matrix is a byproduct of the model. In other embodiments, the process model uses the sequential mode or perturbation method to build the gain matrix. This mode replicates the steps that were originally done in the design of the advanced process control system. When the perturbation method is used, steady state process functionality 130 sequentially adjusts each independent variable (manipulated variable and disturbance variable) and records a value for the change in each associated controlled variable. With this approach, a gain is determined for each independent variable (e.g., manipulated variable and disturbance variable) and each of its corresponding controlled variables by dividing the change in the controlled variable by the change in the corresponding independent variable (the amount of the perturbation). The sequential mode also uses gain process functionality 122 in generating the gain matrix.

At block 211, process 200 passes data based on the matrix with the plurality of gains to the advanced process control system. In one embodiment, process 200 causes digital twin historian 104 of process digital twin computer 106 to pass the matrix with the plurality of gains to advanced process control historian 112 of advanced process control computer 114. In one embodiment, process 200 passes the matrix with the plurality of gains by determining a difference between the plurality of gains in the gain matrix and a corresponding plurality of gains in a reference process gain matrix configured in the advanced process control system. Process 200 passes this difference to the APC historian 112 as a multiplication factor. For example, in one embodiment, the difference is determined by dividing the gain matrix by the prior matrix. In other embodiments, process 200 provides the new gain matrix directly to advanced process control system, e.g., to advanced process control historian 112.

At block 213, process 200 controls operation of the industrial plant through the advanced process control system. In one embodiment, advanced process control computer 114 uses the updated gain matrix received from process digital twin computer 106 to determine new control signals for industrial plant 101. Specifically, advanced process control computer 114 includes advanced process control component 138 that is configured to generate control signals to optimize performance of industrial plant 101. When the new gain matrix is received at historian 112, advanced process control component 138 is configured to re-calculate values for the manipulated variables that are used to control industrial plant 101. These new values are communicated to industrial plant 101 by advanced process control component 138 so that operation of industrial plant 101 is optimized based on the current operational state of industrial plant 101 as reflected by the modification of the process models in process digital twin computer 106 based on the updated data provided by site historian 102.

### Example Application to Hydrocarbon Distillation Process

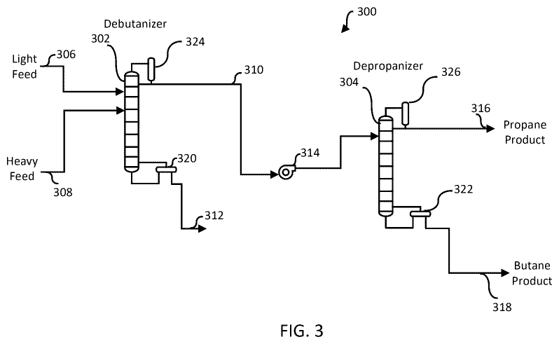

FIG. 3 is a block diagram of one embodiment of a flowsheet or process model 300 of an industrial plant that produces updates to process gains for use by the optimization process for the industrial plant. The industrial plant modeled by process model 300 is one example of the type of industrial plant 101 of FIG. 1. Further, the functions described with respect to the process model 300 are similar to those described with respect to the process model on process digital twin computer 106. Thus, process model 300 is updated from time-to-time so that the steady state gain matrix associated with process model 300 represents the current state of the associated industrial plant thereby enabling proper control of the industrial plant by the advanced process control system.

In this example, process model 300 models an industrial plant that converts hydrocarbon feeds into at least two products: propane and butane. It is understood that this industrial plant and process model is provided by way of example and not by way of limitation. The teachings of the present disclosure apply to a wide variety of industrial plants including but not limited to chemical plants, automotive manufacturing plants, distilleries, oil refineries, fabric manufacturing plant, and/or the like.

Process model 300 includes models of two distillation columns. The first distillation column is debutanizer column 302 and the second distillation column is depropanizer column 304. Process model 300 also accounts for two input feeds of hydrocarbons to debutanizer column 302: a light feed 306 and a heavy feed 308. Debutanizer column 302 separates C4s and lighter hydrocarbons from the heavier components coming from light feed 306 and heavy feed 308. The C4 and lighter hydrocarbons pass into stream 310. In debutanizer column 302, constituents that are C5 and heavier go to stream 312.

Stream 310 is pumped to depropanizer column 304 by pump 314. Depropanizer column 304 separates the C3s from the C4s in stream 310. In depropanizer column 304, C3s predominantly go into the overhead stream and are exit process model 300 at output 316. In this case, the product at output 316 is propane. In depropanizer column 304, C4s predominantly go into bottom stream and exit depropanizer column 304 at output 318. In this case, the product at output 318 is butane.

In both debutanizer column 302 and depropanizer column 304, separation of the various types of hydrocarbons is achieved through a reboiler (heat exchanger) at the bottom of their respective columns that vaporizes liquid at the bottom of the column to provide vapor traffic up the column. For example, debutanizer column 302 includes reboiler 320 and depropanizer column 304 includes reboiler 322.

Both debutanizer column 302 and depropanizer column 304 also include a condenser at the top of their respective columns that condenses the overhead product and pumps liquid back to the column. For example, debutanizer column 302 includes condenser 324 and depropanizer column 304 includes condenser 326.

Basically, in a distillation column, vapor travels up the column and liquid travels down the column. During this process, the various constituents are separated with energy transfer at each stage (tray) in an equilibrium. Heat is applied at the bottom of the column (reboiler 320 and reboiler 322) to get the liquid vaporized to go up the column. Condenser 324 and condenser 326 are located at the top of their respective columns to provide the reflux (liquid going down the column).

Each of the components depicted in FIG. 3 represents a model of a real world element of an industrial plant. The models of the various components are linked together in the process model 300 (flowsheet model). Data from process model 300 is used by an advanced process control system to adjust settings for the industrial plant such that the production of the industrial plant is optimized.

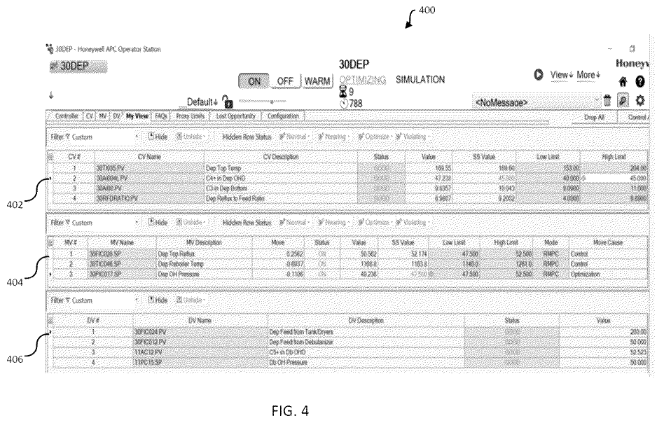

FIG. 4 is a screenshot of one embodiment of a graphical user interface 400 on an operator console of an advanced process control system associated with the flowsheet model of FIG. 3 that illustrates various values for parameters associated with controlled variables (CV), manipulated variables (MV), and disturbance variable (DV). Graphical user interface 400 includes three section that display the controlled variable (section 402), the manipulated variables (section 404), and the disturbance variables (section 406). In this example, graphical user interface 400 shows 4 controlled variables in section 402, three manipulated variables in 404, and four disturbance variables in 406.

Section 402 displays data for each of the controlled variables. For example, section 402 describes the first controlled variable (identified as number 1 in the column headed “CV #”) as “Dep Top Temp”. This controlled variable relates to the temperature at the top of the depropanizer column 304. The second control variable is described as “C4+ in Dep OHD” which means that this controlled variable tracks the amount of C4 and heavier constituents in the overhead of the depropanizer column 304. Similarly, the third controlled variable tracks the amount of C3s in the bottom of depropanizer column 304 and the fourth controlled variable in section 402 relates to the reflux-to-feed ratio in depropanizer column 304. Each of these controlled variables are the variables that the advanced process control system is designed to control for this industrial plant. Graphical user interface 400 presents in section 402 the current value, the steady state value as well as low and high limits for each controlled variable.

Section 404 displays data for each of the manipulated variables. These are the variables that the advanced process control system can use to control the operation of the industrial plant represented by process model process model 300. Section 404 lists three manipulated variables described as “Dep Top Reflux” (a measure of reflux at the top of depropanizer column 304), “Dep Reboiler Temp” (the temperature of reboiler 322 of depropanizer column 304), and “Dep OH Pressure” (the pressure in the overhead of depropanizer column 304). Section 404 displays the amount the variable has to move to reach the control objective (“move”), the value of the manipulated variable, as well as the steady state value and the low and high limits for the manipulated variable.

Section 406 displays data for each of the disturbance variables. These are the variables that the advanced process control system cannot directly control but have an influence on the controlled variables. In this example, there are four disturbance variable that are tracked on graphical user interface 400.

In this embodiment, there are four controlled variables, 3 manipulated variables and 4 disturbance variables. Therefore, the gain matrix derived by process model 300 will have 7 gains for each controlled variable. Advantageously, embodiments of the present invention update these process gains over time, and provides data correspond to those updated gains to the advanced process control system to be used for, e.g., optimization, such that the process gains used by the advance process control system sufficiently represent the current status of the industrial plant.

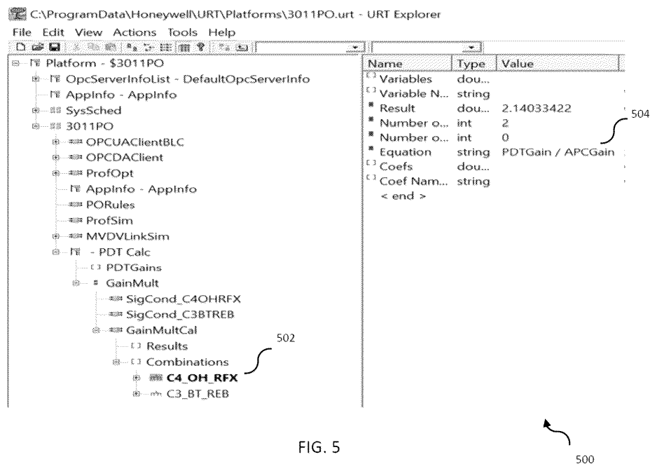

FIG. 5 is screenshot of a graphical user interface 500 that illustrates one embodiment of a process for updating process gains for an optimization process for an industrial plant associated with the flowsheet model of FIG. 3. One the left side of graphical user interface 500, the process for calculating gains in the process digital twin is expanded (PDT Calc). At the bottom of the expansion, the various combinations of controlled variable and independent variables (process gains) are listed. At 502, the specific combination “C4_OH_RFX” is highlighted. This process gain is for C4 in the overhead to the reflux, which is the gain from CV #2 to MV #1. In the right-hand column, at 504, a calculation is defined that represents a change in the process gain to be passed to the advanced process control system. In this case, the change is determined as a multiplication factor according to the following equation:

$$Multiplication Factor = PDT Gain / APC Gain \qquad ( 1 )$$

This equation means that the multiplication factor is determined by dividing the current process gain determined by the process digital twin (PDT Gain) by the reference process gain configured in the advanced process control system (APC gain). This multiplication factor is provided to the advanced process control system to produce the updated process gains to be used by the advanced process control system going forward. This is one embodiment of the process described above with respect digital twin historian 104 passing changes in the process gain matrix to advanced process control computer 114 in the embodiment of FIG. 1.

### Additional Embodiment

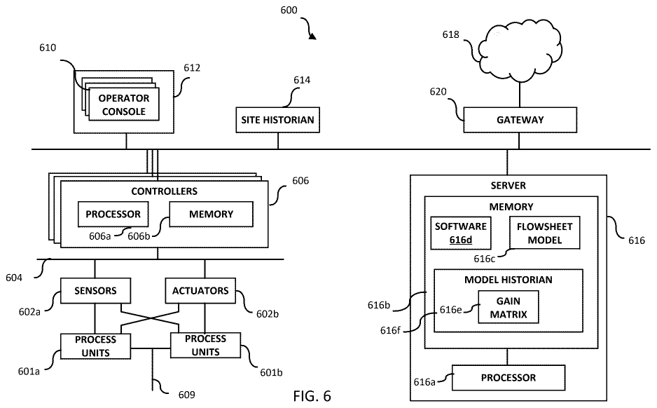

FIG. 6. is one embodiment of a system for optimization of a process in an industrial plant using advanced process control based on process gains that are updated periodically based on current operating conditions of an industrial plant as described above with respect to FIGS. 1-5. As shown in FIG. 6, system 600 includes various components that facilitate production or processing of at least one product or other tangible material. For instance, the system 600 can be used to facilitate control over components in one or multiple industrial plants. Each plant represents one or more processing facilities (or one or more portions thereof), such as one or more manufacturing facilities for producing at least one product or other tangible material. In general, each plant may implement one or more industrial processes and can individually or collectively be referred to as a process system, process unit or object. A process system generally represents any system or portion thereof configured to process one or more products or other materials in some manner.

The system 600 includes field devices comprising one or more sensors 602a and one or more actuators 602b that are coupled between controllers 606 and the processing equipment, shown in simplified form as process unit 601a coupled by piping 609 to process unit 601b. The sensors 602a and actuators 602b represent components in a process system that may perform any of a wide variety of functions. For example, the sensors 602a can measure a wide variety of characteristics in the process system, such as flow, pressure, or temperature. Also, the actuators 602b can alter a wide variety of characteristics in the process system, such as valve openings. Each of the sensors 602a includes any suitable structure for measuring one or more characteristics in a process system. Each of the actuators 602b includes any suitable structure for operating on or affecting one or more conditions in a process system. As described in more detail below, sensors 602a capture data regarding the current status of the industrial plant that can be used to update process gains associated with models used to perform advanced process control for the industrial plant.

At least one network 604 is shown providing a coupling between the controllers 606 and the sensors 602a and actuators 602b. The network 604 facilitates interaction with the sensors 602a and actuators 602b. For example, the network 604 can transport measurement data from the sensors 602a to the controllers 606 and provide control signals from the controllers 606 to the actuators 602b. The network 604 can represent any suitable network or combination of networks. As particular examples, the network 604 can represent at least one Ethernet network (such as one supporting a FOUNDATION FIELDBUS protocol), electrical signal network (such as a HART network), pneumatic control signal network, or any other or additional type(s) of network(s).

The system 600 also comprises various process controllers 606 generally configured in multiple Purdue model levels that may be present at all levels besides level 0, which only includes the field devices (sensors and actuators) and the processing equipment. Each process controller comprises a processor 606a coupled to a memory 606b. The process controllers 606 can be used in the system 600 to perform various functions in order to control one or more industrial processes (e.g., a process system, process unit, or object).

For example, a first set of process controllers 606 corresponding to level 1 in the Purdue model may refer to smart transmitters or smart flow controllers, where the control logic is embedded in these controller devices. Level 1 controllers do not implement Model Predictive Control (MPC). Level 2 generally refers to a distributed control system (DCS) controller, such as the C300 controller from Honeywell International. These level 2 controllers can also include more advanced strategies including machine level control built into the C300 controller, or another similar controller. Level 3 is generally reserved for controllers implemented by the server 616. These controllers interact with the other level (1, 2 and 4) controllers. MPC control can be implemented by controllers at level 2, but is generally implemented at level 3 and level 4. It is noted that not all control systems implement level 1, where the sensors and actuators (level 0) can be directly linked to a level 2 controller without any smart device in level 1. The C300 controller provides basic “loop” control as well as more advanced regulatory control schemes (including machine level control).

The level 1 controllers in the case of smart devices, or level 2 controllers such as the C300 controller, may use measurements from one or more sensors 602a to control the operation of one or more actuators 602b. The level 2 process controllers 606 can be used to optimize the control logic or other operations performed by the level 1 process controllers. For example, the machine-level controllers, such as DCS controllers, at Purdue level 2 can log information collected or generated by process controllers 606 that are on level 1, such as measurement data from the sensors 602a or control signals for the actuators 602b.

A third set of controllers implemented by the server 616 corresponding to level 3 in the Purdue model, known as unit-level controllers which generally perform MPC control, can be used to perform additional functions. The process controllers 606 and controllers implemented by the server 616 can collectively therefore support a combination of approaches, such as regulatory control, advanced regulatory control, supervisory control, and advanced process control. In one arrangement, the third set of controllers implemented by the server 616 comprises an upper-tier controller corresponding to level 4 in the Purdue model, which generally also performs MPC control, also known as a plant-level controller (including Advanced Process Control), coupled to a lower-tier controller corresponding to level 3 in the Purdue model.

The hybrid MPC simulation model (flowsheet or process model) generally resides in a memory (shown as flowsheet model 616c and associated gain matrix 616e stored in model historian 616f in memory 616b as shown in FIG. 6) associated with the upper-tier controller implemented by the server 616, wherein the upper-tier controller uses the flowsheet model to predict movements in the process participates in controlling the plant, and interacting with the flowsheet model to optimize overall economics of the plant including sending an output from the flowsheet model as setpoint targets to the lower-tier controller. The lower-tier controller uses the setpoint targets for diverting the raw material or the intermediate material in the piping network. Advantageously, server 616 receives periodic updates to conditions or the state of the industrial plant under control from site historian 614 based on data received from sensors 602a. With this data, server 616 is able to update flowsheet model 616c to represent the current conditions of the plant. Flowsheet model 616c is then run to produce an updated gain matrix 616e that is used by the advanced process control system to optimize the performance of the industrial plant based on its current operating state or condition.

Each process controller 606, and the controller (s) implemented by the server 616, generally includes any suitable structure for controlling one or more aspects of an industrial process. At least some of the process controllers 606, and process controllers implemented by the server 616 could, for example, represent proportional-integral-derivative (PID) controllers or multivariable controllers, such as controllers implementing MPC or other advanced predictive control (APC). As a particular example, each process controller can represent a computing device running a real-time operating system, a WINDOWS operating system, or other operating system.

At least one of the process controllers 606 shown in FIG. 6 could denote a model-based process controller that operates using one or more process models. For example, each of these process controllers 606 can operate using one or more process models, including a disclosed hybrid MPC simulation (flowsheet) model, to determine, based on measurements from one or more sensors 602a, how to adjust one or more actuators 602b. In some embodiments, each model associates one or more MVs or DVs (often referred to as independent variables) with one or more CV s (often referred to as dependent variables). Each of these process controllers 606 could use an objective function to identify how to adjust its manipulated variables in order to push its CV s to the most attractive set of constraints.

At least one network 608 couples the process controllers 606 and other devices in the system 600. The network 608 facilitates the transport of information between two components. The network 608 can represent any suitable network or combination of networks. As particular examples, the network 608 can represent at least one Ethernet network.

Operator access to and interaction with the process controllers 606 and other components of the system 600 including the server 616 can occur via various operator consoles 610. Each operator console 610 can be used to provide information to an operator and receive information from an operator. For example, each operator console 610 can provide information identifying a current state of an industrial process to the operator, such as values of various process variables and warnings, alarms, or other states associated with the industrial process. Each operator console 610 can also receive information affecting how the industrial process is controlled, such as by receiving setpoints or control modes for process variables controlled by the process controllers 606 or process controller implemented by the server 616, or other information that alters or affects how the process controllers control the industrial process. Each operator console 610 includes any suitable structure for displaying information to and interacting with an operator. For example, each operator console 610 could represent a computing device running a WINDOWS operating system or other operating system.

Multiple operator consoles 610 can be grouped together and used in one or more control rooms 612. Each control room 612 could include any number of operator consoles 610 in any suitable arrangement. In some embodiments, multiple control rooms 612 can be used to control an industrial plant, such as when each control room 612 contains operator consoles 610 used to manage a discrete part of the industrial plant.

The system 600 includes at least one data historian 614, and generally includes at least one server 616. The server 616 is generally in level 3 or 4 in the Purdue model. The server 616 includes a computing device shown as a processor 616a coupled to a memory 616b that stores a disclosed hybrid MPC simulation (flowsheet) model 616c. The memory generally comprises non-transitory computer-readable medium. The processor 616a can comprise a digital signal processor (DSP), a microcontroller, an application specific integrated circuit (ASIC), a general processor, or any other combination of one or more integrated processing devices. Disclosed software for generating a disclosed hybrid MPC simulation (flowsheet) model 616c also generally resides in one or more servers 616, shown as software 616d. The MPC controller utilizing the hybrid MPC simulation (flowsheet) model 616c gathers measurement information from the process controllers 606, including other APC controllers, to adjust the dynamic portion of the hybrid model, synchronizing it to the process conditions. Once synchronized, the hybrid MPC simulation (flowsheet) model generates the control structures necessary to control and optimize operations of the whole plant.

The data historian 614 represents a component that stores various information about the system 600. As described above, data historian 614 receives and stores readings (data) from sensors 602a that indicate the current operating state of the various components of the industrial plant. This data, as described above, is used by flowsheet model 616c to update the advanced process control system with current process gains for the industrial plant. (See, e.g., FIGS. 1-5 and accompanying description). The data historian 614 can also store information that is generated by the various process controllers 606 during the control of one or more industrial processes. The data historian 614 includes any suitable structure for storing and facilitating retrieval of information. Although shown as a single component here, the data historian 614 can be located elsewhere in the system 600, such as in the cloud, or multiple data historians can be distributed in different locations in the system 600.

The server's 616 processor 616a executes applications for users of the operator consoles 610 or other applications. The applications can be used to support various functions for the operator consoles 610, the process controllers 606, or other components of the system 600. Each server 616 can represent a computing device running a WINDOWS operating system or other operating system. Note that while shown as being local within the system 600, the functionality of the server 616 can be remote from the system 600. For instance, the functionality of the server 616 can be implemented in a computing cloud 618, or in a remote server communicatively coupled to the system 600 via a gateway 620.

Although FIG. 6 illustrates one example of an industrial process control and automation system, various changes may be made to FIG. 6. For example, the system 600 can include any number of sensors, actuators, controllers, networks, operator consoles, control rooms, historians, servers, and other components.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory or other non-transitory computer readable medium. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs) or Field Programmable Gate Arrays (FGPAs).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method for updating process gains for an optimization process for an industrial plant, the method comprising:
receiving, from a site historian, data from the industrial plant at a historian of a digital twin of the industrial plant, the digital twin including process model functionalities that model the industrial plant including a plurality of independent variables and a plurality of controlled variables;
preparing the data from the industrial plant for use by the process model functionalities;
updating the process model functionalities with the prepared data;
running the updated process model functionalities;
extracting a matrix with a plurality of gains from the process model functionalities, wherein each gain of the plurality of gains associates one of the plurality of independent variables with a corresponding one of the plurality of controlled variables;
passing data based on the matrix with the plurality of gains to an historian of an advanced process control system (APC); and
controlling operation of the industrial plant through the APC system using the data based on the matrix with the plurality of gains received at the historian of the APC system.

2. The method of claim 1, wherein the plurality of independent variables includes a plurality of manipulated variables and disturbance variables, and wherein extracting the matrix comprises:
sequentially adjusting each of the plurality of manipulated variables and recording a value for each associated controlled variable; and
determining a gain for each manipulated variable and each of its corresponding controlled variables.

3. The method of claim 1, wherein:
running the updated process model functionalities comprises running an open equation model; and
extracting the matrix with the plurality of gains from the process model functionalities comprises extracting a subset of the data from an output of the open equation model.

4. The method of claim 1, wherein passing the data based on the matrix with the plurality of gains comprises:
determining a difference between the plurality of gains in the matrix and a corresponding plurality of gains in a prior matrix; and
deploying the difference as a multiplication factor to the historian of the advanced process control system.

5. The method of claim 4, wherein determining a difference comprises dividing the gain matrix by the prior matrix.

6. The method of claim 1, wherein passing the data based on the matrix with the plurality of gains comprises passing the matrix with the plurality of gains to the historian of the APC system.

7. The method of claim 1, wherein running the updated process model functionalities comprises running the process model functionalities at a selected run frequency.

8. The method of claim 7, further comprising extracting the matrix at the selected run frequency.

9. A system for controlling an industrial plant, the system comprising:
a digital twin computer including process model functionalities that represent one or more processes of the industrial plant, the process model functionalities including a plurality of independent variables and a plurality of controlled variables;
the digital twin computer further including a digital twin historian that is configured to receive data regarding the industrial plant from a site historian of the industrial plant;
wherein the process model functionalities, when run on a processor of the digital twin computer, causes the processor to perform a method including:
receiving, from the site historian, data from the industrial plant at the digital twin historian;
preparing the data from the industrial plant for use by the process model functionalities;
updating the process model functionalities with the prepared data;
running the updated process model functionalities;
extracting a matrix with a plurality of gains from the process model functionalities, wherein each gain of the plurality of gains associates one of the plurality of independent variables with a corresponding one of the plurality of controlled variables;
passing data based on the matrix with the plurality of gains to an historian of an advanced process control system (APC); and
controlling operation of the industrial plant through the APC system using the data based on the matrix with the plurality of gains received at the historian of the APC system.

10. The system of claim 9, wherein the plurality of independent variables includes a plurality of manipulated variables and disturbance variables, and wherein causing the processor to perform the method including extracting the matrix comprises:
sequentially adjusting each of the plurality of manipulated variables and recording a value for each associated controlled variable; and
determining a gain for each manipulated variable and each of its corresponding controlled variables.

11. The system of claim 9, wherein causing the processor to perform the method including:
running the updated process model functionalities comprises running an open equation model; and
extracting the matrix with the plurality of gains from the process model functionalities comprises extracting a subset of the data from an output of the open equation model.

12. The method of claim 9, wherein causing the processor to perform the method including passing the data based on the matrix with the plurality of gains comprises:
determining a difference between the plurality of gains in the matrix and a corresponding plurality of gains in a prior matrix; and
deploying the difference as a multiplication factor to the historian of the advanced process control system.

13. The system of claim 12, wherein causing the processor to perform the method including determining a difference comprises dividing the gain matrix by the prior matrix.

14. The system of claim 9, wherein causing the processor to perform the method including passing the data based on the matrix with the plurality of gains comprises passing the matrix with the plurality of gains to the historian of the APC system.

15. The system of claim 9, wherein causing the processor to perform the method including running the updated process model functionalities comprises running the process model functionalities at a selected run frequency.

16. The system of claim 15, wherein causing the processor to perform the method further comprising extracting the matrix at the selected run frequency.

17. A non-transitory computer readable medium including a set of instructions that, when executed by at least one processor, cause the at least one processor to perform a method including:
receiving, from a site historian, data from an industrial plant at a historian of a digital twin of the industrial plant, the digital twin including process model functionalities that model the industrial plant including a plurality of independent variables and a plurality of controlled variables;
preparing the data from the industrial plant for use by the process model functionalities;
updating the process model functionalities with the prepared data;
running the updated process model functionalities;
extracting a matrix with a plurality of gains from the process model functionalities, wherein each gain of the plurality of gains associates one of the plurality of independent variables with a corresponding one of the plurality of controlled variables;
passing data based on the matrix with the plurality of gains to an historian of an advanced process control system (APC); and
controlling operation of the industrial plant through the APC system using the data based on the matrix with the plurality of gains received at the historian of the APC system.

18. The non-transitory computer readable medium of claim 17, wherein the plurality of independent variables includes a plurality of manipulated variables and disturbance variables, and wherein extracting the matrix comprises:
sequentially adjusting each of the plurality of manipulated variables and recording a value for each associated controlled variable; and
determining a gain for each manipulated variable and each of its corresponding controlled variables.

19. The non-transitory computer readable medium of claim 17, wherein:
running the updated process model functionalities comprises running an open equation model; and
extracting the matrix with the plurality of gains from the process model functionalities comprises extracting a subset of the data from an output of the open equation model.

20. The non-transitory computer readable medium of claim 17, wherein passing the data based on the matrix with the plurality of gains comprises:
determining a difference between the plurality of gains in the matrix and a corresponding plurality of gains in a prior matrix; and
deploying the difference as a multiplication factor to the historian of the advanced process control system.
